(19) United States
(12) Patent Application Publication
(10) Pub. No.: US 2006/0288536 A1
(43) Pub. Date: Dec. 28, 2006

(54) Handle for a tool and a method for attaching a handle to a tool

(76) Inventor: Albert E. Basolt II, Averill Park, NY (US)

Correspondence Address: HESLIN ROTHENBERG FARLEY & MESITI PC, 5 COLUMBIA CIRCLE, ALBANY, NY, 12203, US

(21) Appl. No.: 11/168,735

(22) Filed: Jun. 28, 2005

(51) Int. Cl. B25G 3/32

(52) U.S. Cl. 16/422

(57) ABSTRACT

A removable handle for a tool, for example, for a cylindrical file, a method for attaching the handle to a tool, and a method of using the handle are provided. The handle includes a cylindrical body having a threaded hole extending at least partially through the cylindrical body and at least one radial hole in the body, and a threaded cylindrical rod adapted to engage the threaded hole in the body, wherein the radial hole is adapted to receive a projection of a tool and the threaded rod engages the projection when the threaded rod is rotated into contact with the projection. The handle may be mounted to any tool projection, but may be particularly useful when mounted to a cylindrical file used for sharpening chain saw cutters.

### TECHNICAL FIELD

The invention is related to methods and devices for assisting mechanics in handling hand tools, for example, files, and related tools. More specifically, the present invention comprises a handle that is adapted to be mounted to an elongated extension of a tool to provide a means for grasping and controlling the operation of the tool, for example, to assist loggers in handling circular files when sharpening the cutters of a chain saw.

### BACKGROUND OF THE INVENTION

With use, chain saw cutters become dull or otherwise lose their sharpness. As is known to those skilled in the art, chain saw “cutters” are the individual cutting blades mounted to the chain that ride about the periphery of the chain saw guide bar. During the course of a job, the professional logger or the typical homeowner often must stop operating the chain saw and sharpen the cutters. The typical chain saw cutter cutting surface is circular in shape and this surface is typically manually sharpened by using a circular, or “rat tail,” file. However, the angle of the edge of the cutting surface is critical to the proper operation of the chain saw and great pains are taken to ensure the cutters are individually sharpened at the proper angle. For example, for cutting softwood, the cutting surface of the cutters is sharpened to an angle of about 30 degrees with the respect to the plane of the guide bar. For cutting hardwood, the cutting surface of the cutters is sharpened to an angle of about 25 degrees with the respect to the plane of the guide bar.

In order to achieve these desired cutting surface angles while manually sharpening, the chain saw operator typically must control the direction and orientation of the sharpening tool. Typically, circular files are often provided with a handle, for example, a wooden handle, at one end that is adapted to receive the tapered end of a file. These handles facilitate grasping the file and manipulating the file during sharpening. Devices are known in the art for assisting the sharpener in guiding direction of the file to provide the desired angle. However, the control of the sharpening tool to provide the desired orientation often requires the sharpener to grasp the far end of the file, that is, the end opposite the handle, in order to control the operation of the file. According to prior art methods and practices, the grasping of the far end of a file, for example, of rat tail file, provides limited stability of the filing operation and, due to the narrow shape of such files, can be a safety hazard. Chain saw operators have often injured their hands when filing when the far end of a file pierces the skin of the hand, even when the hand is protected by a glove.

Attempts have been made to overcome the disadvantages and dangers of prior art methods and devices for sharpening chain saws. U.S. Pat. No. 1,375,634 of Hannigan discloses “a supplemental handle” for a flat or rectangular file. U.S. Pat. No. 3,914,839 of Holdsworth discloses a device that attaches to a flat file and provides a handle for grasping the flat file. U.S. Pat. No. 79,709 of Weare discloses a “file handle” mounted to the tapered end of a flat file. However, none of these inventions overcome the limitations and disadvantages inherent in manipulating a file when, for example, sharpening chain saw cutters.

Aspects of the present invention overcome the limitations and disadvantages of the prior art.

### SUMMARY OF THE INVENTION

As a frequent user of chain saws, the inventor often found the need to sharpen his chain saw. However, the inventor often found the existing technique of grasping a chain saw file with one hand on the wooden handle and one hand on the bare opposite end of the file to be cumbersome at best, and sometimes dangerous. As a seasoned mechanic, the inventor developed the present invention to assist in filing chain saw cutters. The inventor also recognized the application of aspects of the invention to other, non-file like, tools, which will be discussed below.

Aspects of the present invention provide devices that can be easily attached to the end of a file or similar tool to provide a structure that can be grasped by the user. The proximal end of the tool may have a handle or handle-like structure that accepts a tool. The present invention provides a device that allows the user to grasp both ends, the proximal end and the distal end, of a tool to provide more accurate and less dangerous handling of a tool, for example, the handling of a file or tool of similar structure.

One aspect of the invention is a handle for a tool, the handle including a body comprising an outer surface and an axis; a threaded hole extending at least partially along the axis of the body, the threaded hole having an internal surface; and at least one substantially radial hole penetrating the outer surface of the body and extending through the internal surface of the threaded hole; and a threaded cylindrical rod adapted to engage the threaded hole in the body, the cylindrical rod having a first end having means for rotating the rod in the threaded hole, and a second end opposite the first end; wherein the at least one substantially radial hole is adapted to receive a projection of the tool, and wherein the second end of the threaded cylindrical rod is adapted to engage the projection when the threaded cylindrical rod is rotated into contact with the projection. In one aspect, the at least one substantially radial hole comprises a plurality of substantially radial holes.

Another aspect of the invention is a method for attaching a handle to a tool having an elongated projection, the method including providing a handle having a body comprising an outer surface and a longitudinal axis; a threaded hole extending at least partially along the longitudinal axis of the body, the threaded hole having an internal surface; and at least one substantially radial hole penetrating the outer surface of the body and extending through the internal surface of the threaded hole; and a threaded cylindrical rod adapted to engage the threaded hole in the body; inserting the elongated projection into the at least one substantially radial hole wherein the elongated projection at least partially extends into the threaded hole; inserting the threaded cylindrical rod into the threaded hole; rotating the threaded cylindrical rod into engagement with the elongated projection to attach the handle to the tool. In one aspect, the tool may be a cylindrical file, a welding rod, or an Allen-type wrench.

A further aspect of the invention is a removable file handle, the file handle including a body having an outer surface and an axis; a threaded hole extending at least partially along the axis of the body, the threaded hole having an internal surface; and a plurality of substantially radial holes of varying diameter penetrating the outer surface of the body and extending through the internal surface of the threaded hole; and a threaded cylindrical rod adapted to engage the threaded hole in the body, the cylindrical rod having a first end including means for rotating the cylindrical rod in the threaded hole, and a second end opposite the first end; wherein the at least one radial hole is adapted to receive a cylindrical file, and wherein the threaded cylindrical rod is adapted to engage and secure the cylindrical file to the handle when the cylindrical rod is rotated into contact with the cylindrical file.

A further aspect of the invention is a method of manipulating a file, the method including mounting a conventional handle to a first end of a file; mounting a handle as recited above in a second end of a file, opposite the first end; grasping the conventional handle in one hand; grasping the handle as recited above in the other hand; and manipulating the file against a surface. In one aspect of the invention, the method comprises a method of sharpening the cutters of a chain saw

These and other aspects, features, and advantages of this invention will become apparent from the following detailed description of the various aspects of the invention taken in conjunction with the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIG. 1 is perspective view of one aspect of the present invention.

FIG. 2 is an exploded view of the aspect of the invention shown in FIG. 1.

FIG. 3 is a perspective view of another aspect of the invention.

FIG. 4 is an exploded perspective view of the aspect shown in FIG. 3.

FIG. 5 is a plan view of the body shown in FIG. 3.

FIG. 6 is an elevation view of the body shown in FIG. 3

FIG. 7 is a plan view of another aspect of the invention.

FIG. 8 is a plan view of another aspect of the invention.

FIG. 9 is a plan view of another aspect of the invention.

FIG. 10 is a perspective view of another aspect of the invention.

FIG. 11 is a perspective view of still another aspect of the invention.

FIG. 12 is a perspective view of another aspect of the invention

FIG. 13 is an exploded perspective view of the aspect of the invention shown in FIG. 12.

FIG. 14 is a side elevation view of aspect shown in FIG. 12.

FIG. 15 is a side elevation view of the threaded insert shown in FIG. 13.

### DETAILED DESCRIPTION OF THE INVENTION

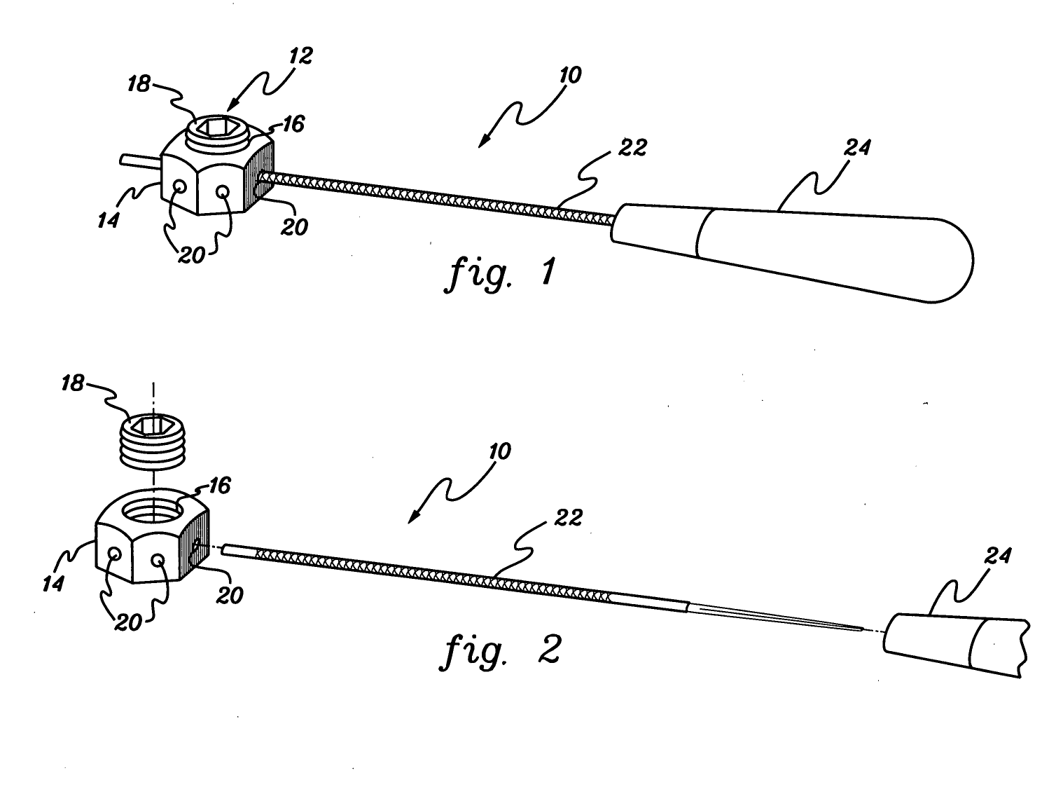

Aspects of the present invention assist the mechanic in handling files and file-like tools. Aspects of the invention may also be useful to the physically disabled, injured, or those hampered by ailments, such as arthritis, for grasping files and file-like tools. FIG. 1 is a perspective view of a tool assembly 10 having a gripping device or handle assembly 12 according to one aspect of the present invention. FIG. 2 is an exploded perspective view of the tool assembly 10 shown in FIG. 1. In one aspect, handle assembly 12 comprises a body 14, for example, a cylindrical body, having a threaded hole 16, and threaded rod, screw, or threaded plug 18 adapted to engage threaded hole 16. According to one aspect of the invention, body 14 includes at least one hole 20, for example, a radial hole, adapted to accept a projection of a tool. Though aspects of the invention may be used for any tool having a projection, the assembly 10 includes a circular file 22 having a conventional file handle 24, for example, a wooden handle.

As shown in FIGS. 1 and 2, aspects of the invention may be used for a circular file 22, for example, a file that may be used to sharpen chain saw cutters. However, it is understood by the inventor that aspects of the invention may be to provide a handle or handle-like structure to any tool or related item having a projection, for example, an elongated projection, such as a file, a welding rod, or an Allen-type wrench, among others, that may be inserted into one of the holes 20.

The aspect of the invention shown in FIGS. 1 and 2 is a prototype of the invention fabricated by the inventor from readily available hardware for testing and evaluating the invention. Specifically, in the aspect of the invention shown in FIGS. 1 and 2, handle body 14 is a conventional threaded hexagonal nut and threaded rod 18 comprises a modified setscrew sized to engage the hex nut. For example, in one aspect, handle body 14 may comprise an ANS hex nut having a nominal size of between ¼ inch to 4 inches, and typically having a nominal size between ¾ inches and 1½ inches. Though the inventor found this aspect of the invention to be effective for testing and evaluation, the inventor recognizes that the invention may be adapted for many different sizes and shapes of structures while providing the desired body 14 and threaded rod 18 aspects of the invention. The following discussion and related drawings discuss and illustrate many typical aspects of the present invention which reflect different embodiments which are based upon the prototype shown in FIGS. 1 and 2.

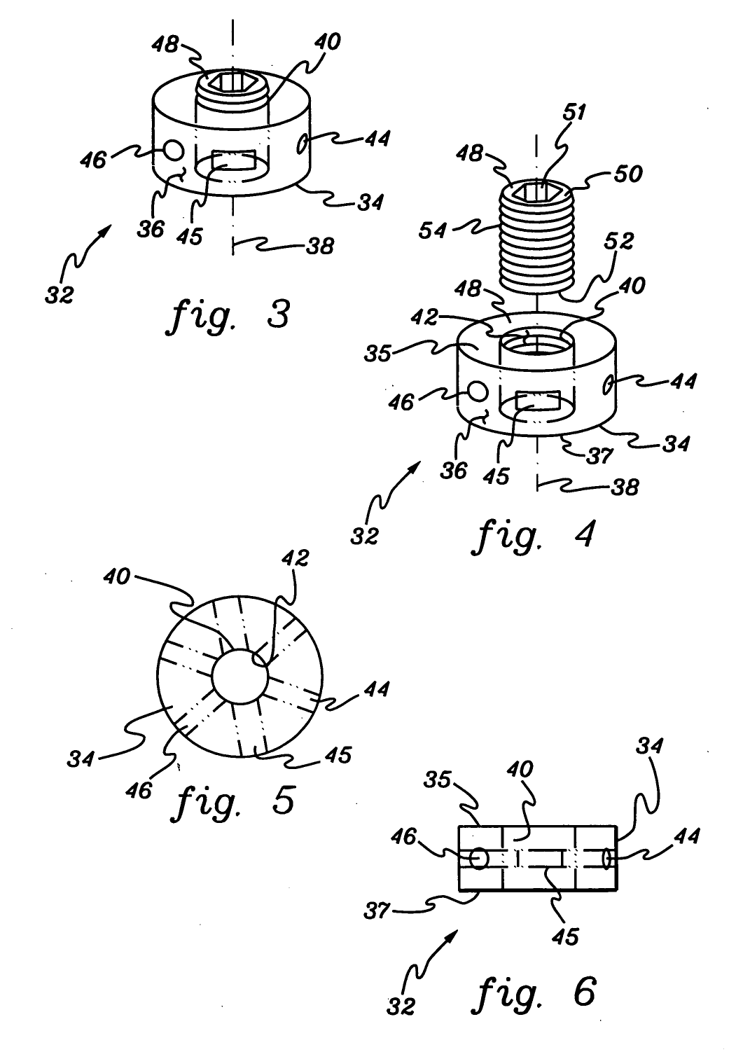

FIG. 3 is a perspective view of another, more general, handle assembly 32 that provides substantially the same function as handle 12 shown in FIGS. 1 and 2. FIG. 4 is an exploded perspective view of the handle assembly 32 shown in FIG. 3. According to one aspect of the invention, handle 32 comprises a body 34, for example, a cylindrical body, having an outer surface 36, an axis 38, for example, a longitudinal axis, and a threaded hole 40 extending at least partially along the axis 38 of body 34. FIG. 5 is a plan view of handle body 34 shown in FIG. 4 and FIG. 6 is an elevation view of handle body 34 shown in FIG. 4. In one aspect, body 34 may have a top 35 and a bottom 37. In one aspect, threaded hole 40 may extend completely through body 34; in another aspect, threaded hole 40 may at extend only partially through body 34. Threaded hole 40 typically has an internal surface 42, for example, an internal threaded surface 42. According to an aspect of the invention, handle 32 also includes a at least one hole 44, 45, and 46, for example, a substantially radial hole, penetrating the outer surface 36 of body 34 and extending through the internal surface 42 of threaded hole 40.

As shown in FIGS. 3-6, holes 44, 45, and 46, may take any appropriate geometric shape, for example, depending upon the shape of the tool to which handle assembly 32 may be attached. For example, holes 44, 45, and 46 may be circular or rectangular, as shown, but holes 44, 45, and 46 may also be oval, elliptical, triangular, square, rectangular, pentagonal, hexagon, or octagonal, among other shapes. In one aspect, holes 44, 45, and 46 may have a broad variety of sizes and shapes and may vary in size and shape in body 34. For example, in one aspect body 34 may have three circular holes, for example, through holes, having diameters of about 0.25 inches, about 0.1875 inches, and about 0.125 inches in diameter, respectively. Cylindrical body 34 may have an outer dimension, for example, a diameter, of between about 0.25 inches and about 12 inches, and typically has an outer dimension of between about 0.5 inches and about 3 inches. Cylindrical body 34 may have a height of between about 0.25 inches and about 6 inches, and typically has a height of between about 0.5 inches and about 2 inches.

As shown in FIGS. 3 and 4, handle assembly 32 also includes a threaded cylindrical rod, insert, or plug 48. Threaded rod 48 is typically adapted to engage threaded hole 40 in body 34. Threaded rod 48 may include a first end 50 and a second end 52. In one aspect, first end 50 may include means 51 for rotating rod 48 in threaded hole 40. For example, in one aspect, first end 50 of rod 48 may include an indention or a projection adapted to be engaged by a tool. For example, in one aspect, means 51 in first end 50 may comprise a slot or an indentation adapted to be engaged by a screwdriver or Allen-type wrench or hex wrench. The indentation may comprise any conventional drive, for instance, a slotted, phillips, pozidriv, torx, hex, robertson, tri-wing, torq-set, or spanner drives, and the like. In one aspect, the means 51 may include a projection, such as a rectangular nub, adapted to be engaged by a wrench or pliers, among other tools. In one aspect of the invention, threaded rod 48 may comprise the threaded shank of a bolt and means 51 may comprise the head of the bolt, for example, a hex head of a hex bolt or the socket head of a socket head cap screw, among other conventional fasteners.

In one aspect of the invention rod 48 includes external threads 54, which typically are adapted to engage the threads in hole 42. Threads 54 may extend at least partially along the length of rod 48. As shown in FIG. 4, in one aspect, threads 54 extend substantially along the entire length of rod 48. Threads 54 may be course, for example, UN, UNC, or UNRC threads, or fine, for example, UNF, UNRF, UNEF, or UNREF threads. Threads 54 may also comprise ACME threads. Threads 54 may be left-handed or right-handed threads. Accordingly, internal surface 42 of body 34 may have complementary internal threads as appropriate. Threads 54 and internal surface 42 may also included American National Standard (ANS) threads or metric threads.

According to the present invention, handle 32 may be adapted to engage any projection of a tool, for example, the cylindrical end of circular file 22 shown in FIG. 1, and provide an easily graspable structure or handle whereby the tool can be readily grasped and/or manipulated. In addition, handle 32 may provide a protective obstruction over a projection of a tool that increases the safety with which the tool can be handled. According to an aspect of the invention, at least one of the holes 44, 45, and 46 is adapted to receive a projection of a tool whereby the projection may be inserted into hole 44, 45, and 46 whereby the projection extends into threaded hole 40. After insertion of the projection, threaded rod 48 may be threaded into hole 40 whereby the second end 52 of threaded rod 48 contacts and bears against the projection. With sufficient tightening of the threaded rod 48 in threaded hole 40, for example, by means of a hex wrench, and, for example, the bearing of the second end 52 of threaded rod 48 against the projection and the consequent bearing of the projection against the sides of hole 44, 45, or 46, handle 32 may be securely engaged with the projection. In one aspect, at least one of the holes 44, 45, or 46 may extend completely through body 34.

Again, in one aspect of the invention, handle 32, and the related handles shown and discussed, may be adapted for mounting to a file, for example, a circular file. In another aspect of the invention, handle 32 may be adapted to mounting to a welding rod or an Allen-type wrench, among others tools.

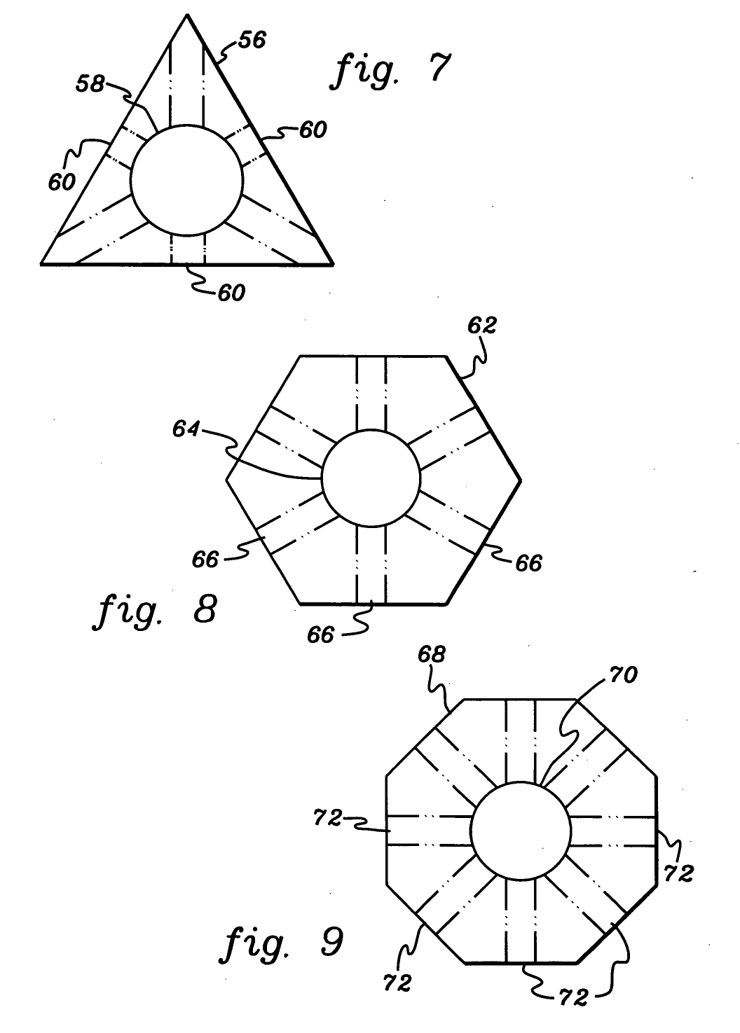

FIGS. 7 through 9 are plan views of further aspects of the invention. As shown in FIG. 7, body 34 shown in FIGS. 3 through 6 may be a triangular cylindrical body 56 having a threaded hole 58 and one or more holes 60, for example radial holes. As shown in FIG. 8, body 34 shown in FIGS. 3 through 6 may be a hexagonal cylindrical body 62 having a threaded hole 64 and one or more holes 66. As shown in FIG. 9, body 34 shown in FIGS. 3 through 6 may be also be a octagonal cylindrical body 68 having a threaded hole 70 and one or more holes 72. As discussed above with respect to holes 44, 45, and 46, holes 60, 66, and 72 may have a broad variety of sizes and shapes and may vary in size and shape in each respective body. In the aspects of the invention shown in FIGS. 3-9, only a single threaded hole, for example, 40, is shown. In one aspect of the invention, two or more threaded holes 40 may be provided. For example, in one aspect, two or more laterally spaced threaded holes in body 34 may be provided having respective radial holes, for example, holes 44, 45, or 46. The two or more threaded holes may have parallel axes or non-parallel axes.

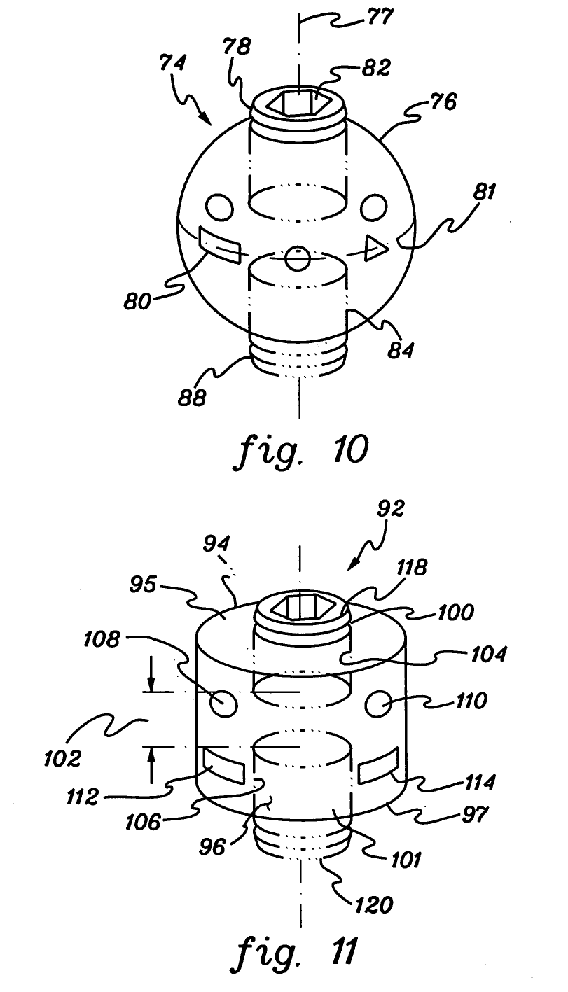

FIG. 10 is a perspective view of another handle assembly 74 according to another aspect of the invention. In addition to being cylindrical, in one aspect of the invention, the handle may be spherical in a manner similar to handle 74, or hemispherical. According to this aspect of the invention, handle assembly 74 may comprise a spherical body 76 or hemispherical body (shown by equator 81 in phantom) having an axis 77, at least one threaded hole 78, one or more holes 80, and at least one threaded rod or plug 82. As shown in FIG. 10, holes 80 may assume a multitude of shapes and sizes and, as shown in FIG. 10, may assume multiple orientations relative to the axis 82 of spherical body 76. For example, holes 80 may be positioned along the equator 81 of spherical body 76 and project radially inward, or holes 80 may be positioned at a latitude above or below equator 81, for example, about 30 degrees to about 60 degrees above or below equator 81, of spherical body 76. Holes 80 may project radially inward, for example, radially inward toward axis 77 and substantially perpendicular to axis 77. In addition, as shown in FIG. 10, handle 74 may include at least one additional threaded hole 84 having at least an additional threaded rod or plug 88 (shown in phantom). In one aspect of the invention, handle 74 may include one or more additional threaded holes and threaded plugs oriented substantially perpendicular to axis 77 or oblique to axis 77 and be adapted to engage one or more through holes to retain a projection of a tool. In this aspect of the invention, handle 74 provides a convenient and ergonomic shape that can be easily grasped by the user. The diameter of body 76 may vary from about 1 inches to about 10 inches, but is typically between about 1 inches and about 3 inches in diameter.

FIG. 11 is a perspective view of another handle assembly 92 according to another aspect of the invention. Handle assembly 92 is similar to handle assembly 32 shown in FIG. 3, except handle assembly 92 may have holes for accepting tool projections positioned at multiple elevations. According to this aspect of the invention, handle assembly 92 includes a body 94, for example, a circular cylindrical body (though any shaped cylindrical body may be provided) having an outer surface 96, an axis 98, for example, a longitudinal axis, and at least one threaded hole 100 extending at least partially along the axis 98 of body 94. In one aspect, body 94 may have a top 95 and a bottom 97. In one aspect, threaded hole 100 may extend completely through the body 94. In another aspect of the invention, one threaded hole 100 may extend from the top 95 at least partially along axis 98 and another threaded hole 101 may extend from the bottom 97 at least partially along the axis 98 of body 94. The bottom of threaded holes 100, 101 may be separated by a thickness 102. Threaded holes 100, 101 typically have internal threaded surface 104 and 106, respectively.

According to one aspect of the invention shown in FIG. 11, handle assembly 92 includes at least one hole 108, 110, 112, and 114, for example, a substantially radial hole, penetrating the outer surface 96 of body 94 and extending through one of the internal surfaces 104, 106 of threaded holes 100, 101, respectively. Again, as shown in FIG. 11, holes 108, 110, 112, and 114 may take any appropriate geometric shape, for example, depending upon the shape of the tool to which handle assembly 92 may be attached. For example, holes 108, 110, 112, and 114 may be circular, rectangular, oval, elliptical, triangular, square, rectangular, pentagonal, hexagon, or octagonal, among other shapes. In one aspect, holes 108, 110, 112, and 114 may have a broad variety of sizes and shapes and may vary in size and shape in body 94.

As shown in FIG. 11, handle assembly 92 also includes at least one threaded cylindrical rod or plug 118 and 120. Threaded rods 118, 120 are typically adapted to engage threaded hole 100, 101 in body 94, and may have one of the thread specifications referenced above. In one aspect, threaded rods 118, 120 may include means for rotating rods 118, 120, for example, indentations, such as hex holes, or projections, as discussed above, which may be engaged by an appropriate tool.

According to this aspect of the invention, handle assembly 92 may provide multiple holes for engaging and securing handle assembly 92 to many different sized and shaped tools, for example, circular and rectangular files or rasps of varying size and shape.

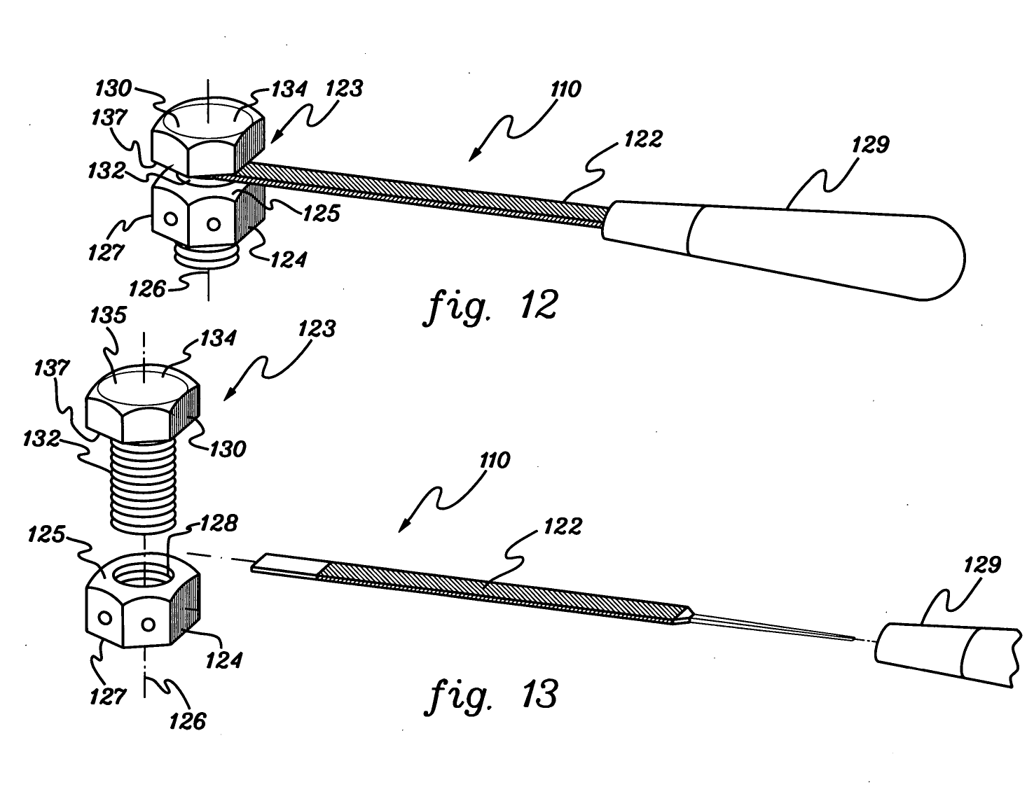

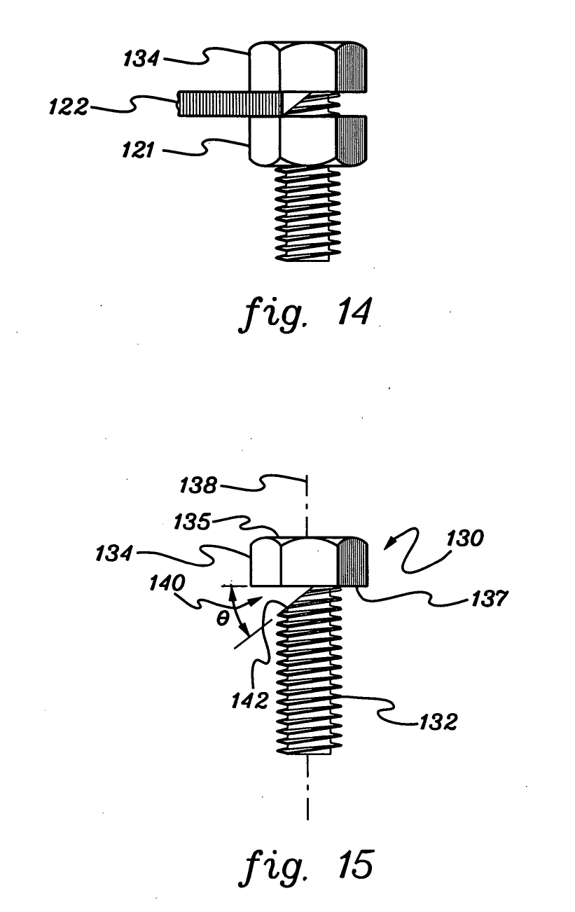

FIG. 12 is a perspective view of an assembly 110 according to another aspect of the invention. FIG. 13 is an exploded perspective view of assembly 110 shown in FIG. 12. FIG. 14 is a side elevation view of assembly 110 shown in FIG. 12. According to this aspect of the invention, assembly 110 includes a handle assembly 123 having a body 124, for example, a circular cylindrical body (though any shaped cylindrical body may be provided) having an axis 126 and at least one threaded hole 128 extending at least partially along the axis 126 of body 124. In one aspect, handle assembly 123 is adapted to engage a tool 122, for example, a rectangular file shown. Tool 122 may include a conventional handle 129, as discussed above. Body 124 typically includes a top surface 125 and a bottom surface 127. According to this aspect of the invention, handle assembly 122 also includes a threaded insert 130 adapted to engage threaded hole 128. Threaded insert 130 comprises a threaded rod 132 having an axis 138 and an annular projection 134, for example, an annular ring, of greater diameter than the diameter of threaded rod 132. Annular projection 134 includes a top surface 135 and a bottom surface 137. FIG. 15 is a side elevation view of threaded insert 130.

According to one aspect of the invention, when threaded insert 130 is inserted into threaded hole 128, top surface 125 of body 124 and bottom surface of annular projection 137 provide means for clamping handle assembly 123 to the projection of tool 122, for example, a rectangular projection such as the rectangular file shown in phantom in FIGS. 12, 13, and 14. As shown in FIG. 15, according to one aspect of the invention, threaded rod 130 may include at least one recess 140, for example, one recess 140 positioned adjacent to bottom surface 137 of annular projection 134. According to this aspect of the invention, recess 140 provides additional space for the insertion of the tool projection between bottom surface 137 and top surface 125 to provide greater bearing surface area against the tool projection than would be available without the recess 140. According to one aspect, the sides 142 of recess 140 may be substantially perpendicular to the axis 138 of threaded rod 132. In another aspect, the sides 142 of recess 140 may form a substantially oblique angle θ with bottom surface 137 of threaded rod 132, for example, an angle between about 30 and 60 degrees with bottom surface 137.

In one aspect of the invention, the handle assembly 123 shown in FIGS. 12-15 may also be used as a filing guide for a rectangular file, for example, rectangular file 122 shown in FIGS. 12 and 13. In one aspect, two or more handle assemblies 123 may be mounted to an elongated edge of file 122, for example, by tightening insert 130 in body 124 about an edge of file 122. Thus mounted, the gap between the two or more handle assemblies provided by the space between bottom surface 137 of insert 130 and the top surface 125 of body 124 may provide a pathway for passing the edge of file 122 over a surface, for example, over the edge of a chain saw guide bar to remove burrs or sharp edges. In one aspect, the bottom surfaces 137 of insert 130 and the top surfaces 125 of body 124 may provide guide surfaces for assisting the handling of file 122 when filing chain saw bar edges and similar structures.

Again, developing this aspect of the invention, the inventor tested and evaluated the invention by using readily available hardware. For example, in fabricating a prototype of assembly 110, the inventor used a hex head nut for body 124 and a hex head bolt for insert 130. In one aspect, insert 130 may comprise a bolt, whereby the threaded shank of the bolt comprises threaded rod 132 and the bolt head comprises the annular projection 134. Similar to the aspects of the invention shown in FIGS. 1-11, body 124 and threaded rod 132 may take assorted shapes and dimensions while still providing the function of the aspect of the invention shown in FIGS. 12-15.

Aspects of the invention may be adapted to accept a handle or other extension that facilitates grasping or tightening aspects of the invention. For example, in one aspect, rods or inserts 18, 48, 82, 88, 118, 120, and 130 may include an elongated extension or handle that extends along the axis of the insert or plug and can easily be grasped by the operator. In one aspect, the insert or plug may include an elongated extension or handle that projects at an angle to the axis of the insert. For example, in one aspect, the extension or handle may extend at an angle of about 90 degrees from the axis of inserts 18, 48, 82, 88, 118, 120, and 130 and, among things, provide a torque arm for tightening the insert into its respective threaded hole.

In one aspect of the invention, bodies 14, 34, 76, 94, 124, and 127, and rods 18, 48, 82, 88, 118, 120, and 132 may be fabricated from any metallic or non-metallic structural metal. For example, in one aspect, bodies 14, 34, 76, 94, 124, and 127, and rods 18, 48, 82, 88, 118, 120, and 132 may be fabricated from one or more of the following metals iron, steel, stainless steel, aluminum, titanium, nickel, magnesium, brass, bronze, or any other structural metal; one or more of the following plastics; a polyamide (PA), for example, nylon; a polyethylene (PE); a polypropylene (PP); a polyester (PE); a polytetraflouroethylene (PTFE); an acrylonitrile butadiene styrene (ABS); a polycarbonate (PC); or a polyvinylchloride (PVC), among other plastics; or from wood. In one aspect, bodies 14, 34, 76, 94, 124, and 127 may be fabricated from stainless steel, for example, a 300 or 400 series stainless steel, and rods 18, 48, 82, 88, 118, 120, and 132 may be fabricated from tool steel.

In one aspect of the invention, bodies 14, 34, 76, 94, and 124, and rods 18, 48, 82, 88, 118, and 120 may be fabricated by any conventional fabrication process, for example, machined from stock items, forged, cast, and welded, among other processes.

Aspects of the invention may be used to facilitate the use of a file, for example, the use of a cylindrical file when filing the cutters of a chain saw. For example, in one aspect, as shown in FIG. 1, a conventional handle 24 may be mounted to the tapered end of a cylindrical, or rat tail, file and a handle according to aspect of the present invention, for example, handle 12 in FIG. 1, may be mounted to the distal end of the file, for example, the non-tapered end. A mechanic may then grasp conventional handle 24, for example, in a right hand, and handle 12, for example, in a left hand and manipulate file 22 with greater ease and accuracy, and less potential for injury. Any one of the aspects of the invention disclosed herein may be used to file chain saw cutters, among other filing and non-filing uses.

In another aspect of the invention, the devices shown in FIGS. 1-15 may be used various non-filing applications. The following description of alternative uses of aspect of the invention will refer to the aspect shown in FIGS. 1-15; however, it will be understood by those of skill in the art that other aspects of the invention may be utilized in providing the function provided. For example, in one aspect of the invention, the devices shown in FIG. 1-15 may be mounted to a welding rod or solder and provide a means to facilitate handling of welding rod and solder. When brazing, welding, or soldering, aspects of the invention can facilitate handling of the work consumable material, such as the welding rod, when aspects of the invention are mounted to the consumable material. Even with the glove used as protection from the heat, aspects of the invention provide the operator with improved handling and, therefore, a safer work environment.

In another aspect of the invention, the devices shown in FIGS. 1-15 may provide a handle for an Allen-type wrench, for example, a hex wrench, though the Allen-type wrench may drive that is hexagonal or any other conventional drive, for instance, a slotted, phillips, pozidriv, torx, hex, robertson, tri-wing, torq-set, or spanner drives, and the like. Again, mounting aspects of the present invention to a hex wrench provides the mechanic with improved handling and, therefore, a safer work environment.

In a further aspect of the invention, aspects of the invention may be used to facilitate wire stripping. For example, in one aspect, a wire having insulation may be inserted through one of the holes 20 in body 14 or holes 44 in body 34 and be engaged between the holes and the respective insert when the insert is tightened. By grasping body 14 or 34 in one handle, for example, and pulling on the wire with the other hand, the wire insulation can be removed with relative ease.

Aspects of the invention may also be used as a wire or a rod coupler. For example, in one aspect, two or more wires, for example, copper or steel wires or rods, may be inserted through holes 20 in body 14 or holes 44 in body 34, for example, opposite holes, and threaded rods, 18 or 48, respectively, may be tightened whereby the wires are rigidly engaged between rod 18 or 38 and bodies 14 and 34, respectively. In one aspect of the invention, a second rod 18 or 38 may also be threaded into the opposite end of threaded hole 16 or 40, respectively, whereby the wires are pinched between the two opposing inserts. Other structures may also be coupled according to aspects of the invention.

In another aspect of the invention, the threaded rod 18 or 48 (See FIG. 1 or 3.) may be used as a dye to repair external damaged threads, for example, damaged tire lug threads. In one aspect, at least the threads 54 of rod 48 may be made from hardened steel, for example, tool steel, and threaded rod 48 may be threaded onto a bolt or stud of comparable diameter having damaged threads to restore, at least partially, the damaged threads.

Aspects of the invention may be used with an elongated structure, such as a rod, pole, or stick to provide a depth or distance gauge. For example, in one aspect, a metal rod may be inserted into hole 44 in body 34, as shown in FIG. 3, and threaded rod 48 may be tightened to engage the rod. The location of body 34 on the rod can be varied as needed to provide a distance gage indication from the distal end of the rod to the surface 36 of body 34.

In another aspect of the invention, the threaded rod 18 or 48, shown in FIG. 2 or 4, respectively, may also be used as a tap, for example, to chase or restore the internal threads of a threaded hole or nut. In one aspect, the threaded rod or insert 130 shown in FIG. 15 may be used as a tap or thread chaser. In one aspect, the recess 140 in threaded insert 130 may function as a cavity to collect the material, for example, the shavings, removed while tapping or chasing, and facilitate tapping or chasing.

Aspects of the invention may also be used as an aid to extracting fasteners, for example, nails or screws. For instance, in one aspect, aspects of the invention may be mounted to fasteners that have been damaged or are otherwise difficult to remove from a material in which they are imbedded. For example, the handle shown in FIG. 1-15 may be mounted to a nail or screw from which its head has inadvertently been removed and used to grasp the fastener to extract the fastener it or as a means to engage the claw of a hammer, and the like, to extract the fastener.

Aspects of the invention may also be used as an aid in grasping wires, rods, or cables, for example, as a replacement for knobs or handles. For example, the handles shown in FIG. 1-15 may be used to replace lost or broken knobs or handles from machinery control devices, such as choke wires or on-off switches, in, for example, heavy machinery, such as bulldozers, skidders, tractors, backhoes, any diesel-powered equipment, and the like. Aspects of the invention may also be used for control cables and related devices light machinery, such as lawn mowers, lawn tractors, snow blowers, and the like.

Other uses of aspect of the present invention will be apparent to those of skill in the art.

While several aspects of the present invention have been described and depicted herein, alternative aspects may be effected by those skilled in the art to accomplish the same objectives. Accordingly, it is intended by the appended claims to cover all such alternative aspects that fall within the true spirit and scope of the invention.

1. A handle for a tool, the handle comprising:
a body comprising:
an outer surface and an axis;
a threaded hole extending at least partially along the axis of the body, the threaded hole having an internal surface; and
at least one substantially radial hole penetrating the outer surface of the body and extending through the internal surface of the threaded hole; and
a threaded cylindrical rod adapted to engage the threaded hole in the body, the cylindrical rod having a first end having means for rotating the rod in the threaded hole, and a second end opposite the first end;
wherein the at least one substantially radial hole is adapted to receive a projection of the tool, and wherein the second end of the threaded cylindrical rod is adapted to engage the projection when the threaded cylindrical rod is rotated into contact with the projection.

2. The tool handle as recited in claim 1, wherein the at least one substantially radial hole comprises a plurality of substantially radial holes.

3. The tool handle as recited in claim 2, wherein the plurality of substantially radial holes comprise holes of varying size.

4. The tool handle as recited in claim 1, wherein the means for rotating the rod comprises one of an indentation and a projection adapted to accept a tool.

5. The tool handle as recited in claim 1, wherein the second end of the threaded cylindrical rod is adapted to engage and substantially secure the tool handle to the projection.

6. The tool handle as recited in claim 1, wherein the body comprises one of a circular cylindrical body, a triangular cylindrical body, a rectangular cylindrical body, a pentagonal cylindrical body, a hexagonal cylindrical body, an octagonal cylindrical body, and a spherical body.

7. The tool handle as recited in claim 1, wherein the threaded hole extending at least partially along the axis of the body extends completely through the body.

8. The tool handle as recited in claim 1, wherein the at least one substantially radial hole penetrating the outer surface of the body comprises a proximal radial hole penetrating a proximal outer surface of the body and a distal radial hole penetrating a distal outer surface of the body, the proximal and distal radial holes being substantially co-axial.

9. The tool handle as recited in claim 7, wherein proximal radial hole and the distal radial hole are adapted to receive the projection of the tool.

10. The tool handle as recited in claim 1, wherein the projection of a tool comprises one of a cylindrical file, a welding rod, and an Allen-type wrench

11. A method for attaching a handle to a tool having an elongated projection, the method comprising:
providing a handle comprising:
a body comprising:
an outer surface and a longitudinal axis;
a threaded hole extending at least partially along the longitudinal axis of the body, the threaded hole having an internal surface; and
at least one substantially radial hole penetrating the outer surface of the body and extending through the internal surface of the threaded hole; and
a threaded cylindrical rod adapted to engage the threaded hole in the body;
inserting the elongated projection into the at least one substantially radial hole wherein the elongated projection at least partially extends into the threaded hole;
inserting the threaded cylindrical rod into the threaded hole;
rotating the threaded cylindrical rod into engagement with the elongated projection to attach the handle to the tool.

12. The method as recited in claim 11, wherein the tool comprises one of a cylindrical file, a welding rod, and an Allen-type wrench.

13. The method as recited in claim 11, wherein the at least one substantially radial hole penetrating the outer surface of the body comprises a proximal radial hole penetrating a proximal outer surface of the body and a distal radial hole penetrating a distal outer surface of the body, the proximal and distal radial holes being substantially co-axial, and wherein inserting the elongated projection into the at least one substantially radial hole comprises inserting the elongated projection into the proximal radial hole and into the distal radial hole.

14. The method as recited in claim 11, wherein the threaded cylindrical rod includes at least one of one of a cavity and a projection adapted to accept a tightening tool, and wherein rotating the threaded cylindrical rod comprises engaging one of the cavity and the projection with the tightening tool and rotating the cylindrical rod.

15. The method as recited in claim 11, wherein the tool having an elongated projection comprises a cylindrical file, wherein the method comprises a method for attaching a handle to a cylindrical file.

16. A removable file handle, the file handle comprising:
a body comprising:
an outer surface and an axis;
a threaded hole extending at least partially along the axis of the body, the threaded hole having an internal surface; and
a plurality of substantially radial holes of varying diameter penetrating the outer surface of the body and extending through the internal surface of the threaded hole; and
a threaded cylindrical rod adapted to engage the threaded hole in the body, the cylindrical rod having a first end including means for rotating the cylindrical rod in the threaded hole, and a second end opposite the first end;
wherein the at least one radial hole is adapted to receive a cylindrical file, and wherein the threaded cylindrical rod is adapted to engage and secure the cylindrical file to the handle when the cylindrical rod is rotated into contact with the cylindrical file.

17. The removable file handle as recited in claim 16, wherein the body comprises one of a circular cylindrical body, a triangular cylindrical body, a rectangular cylindrical body, a pentagonal cylindrical body, a hexagonal cylindrical body, an octagonal cylindrical body, and a spherical body.

18. The removable file handle as recited in claim 16, wherein the threaded hole extending at least partially along the longitudinal axis of the body extends completely through the body.

19. The removable file handle as recited in claim 16, wherein the plurality of substantially radial holes penetrating the outer surface of the body comprise a plurality of sets of proximal radial holes penetrating a proximal outer surface of the body and distal radial holes penetrating a distal outer surface of the body, each proximal radial hole and distal radial hole in each set being substantially co-axial.

20. The removable file handle as recited in claim 16, wherein cylindrical file comprises one of a circular cylindrical file, a triangular cylindrical file, and a rectangular cylindrical file.
